(19) United States
(12) Patent Application Publication
(10) Pub. No.: US 2023/0275360 A1
(43) Pub. Date: Aug. 31, 2023

(54) SYSTEMS AND METHODS FOR OPTIMIZING AN ANTENNA ARRAY TO SUPPRESS SIDE-LOBE POWER

(71) Applicant: Toyota Motor Engineering & Manufacturing North America, Inc., Plano, TX (US)

(72) Inventor: Paul Donald Schmalenberg, Ann Arbor, MI (US)

(73) Assignee: Toyota Motor Engineering & Manufacturing North America, Inc., Plano, TX (US)

(21) Appl. No.: 17/874,936

(22) Filed: Jul. 27, 2022

Related U.S. Application Data
(60) Provisional application No. 63/314,081, filed on Feb. 25, 2022.

(51) Int. Cl. H01Q 21/00; H01Q 21/22; H01Q 1/32; G06F 30/10

(52) U.S. Cl. CPC H01Q 21/0087; H01Q 21/22; H01Q 1/3233; G06F 30/10; G06F 2111/08

(57) ABSTRACT

System, methods, and other embodiments described herein relate to computing positions for manufacturing elements of an antenna array using randomization and gradient operations that suppress side-lobe power. In one embodiment, a method includes computing positions for elements on an antenna array within a placement area using randomization that accounts for varying quantities of the elements according to a distance constraint and a side-lobe power. The method also includes adjusting the placement area according to a location associated with one of the elements. The method also includes optimizing, in response to the elements satisfying criteria after predetermined iterations, the positions for a physical layout of the antenna array using a gradient operation according to the side-lobe power.

### CROSS-REFERENCE TO RELATED APPLICATIONS

This application claims benefit of U.S. Provisional Application No. 63/314,081, filed on, Feb. 25, 2022, which is herein incorporated by reference in its entirety.

### TECHNICAL FIELD

The subject matter described herein relates, in general, to optimizing configurations of an antenna array, and, more particularly, to computing positions for elements of the antenna array using randomization and gradient operations that suppress side-lobe power.

### BACKGROUND

Systems use antennas for signaling, communicating wirelessly, scanning, and so on. For example, vehicles use signals from a radar sensor to facilitate perceiving other vehicles, obstacles, pedestrians, and additional aspects of a surrounding environment. Here, a radar sensor can scan the surrounding environment, while logic associated with the radar sensor analyzes acquired data to detect the presence of objects within the surrounding environment. In one approach, the radar sensor uses an antenna array that electronically scans an environment using various beams. Here, data from the radar sensor using the beams is useful for improving perceptions of the surrounding environment so that systems such as automated driving systems (ADS) can perceive the noted aspects and accurately plan.

In various implementations, a system selecting a configuration for an antenna array within a confined space encounters irregular configurations that form distorted beams having diminished main-lobes. Elevated side-lobes associated with a distorted beam can also interfere with the operation of the antenna array. For example, the system scanning an environment with a pattern that is partly hemispherical experiences reduced accuracy due to beam irregularities. Furthermore, configurations increasing space for an antenna array to address diminished main-lobes can reduce manufacturing efficiencies and yield.

### SUMMARY

In one embodiment, example systems and methods relate to computing positions for manufacturing elements of an antenna array using randomization and gradient operations that suppress side-lobe power, such as during adaptive beamforming. In various implementations, systems that select a layout for manufacturing an antenna array within space constraints encounter irregular configurations that distort beams. For example, a distorted beam formed by an antenna array adaptively can have a diminished main-lobe power and an elevated side-lobe power that reduces accuracy for scanning or other applications. Therefore, in one embodiment, an optimization system computes the initial positions of elements (e.g., emitters, conductors, etc.) on an antenna array using a randomization method (e.g., a Monte Carlo method) accounting for element quantities that vary from additions or subtractions. In particular, the randomization method efficiently searches a population (e.g., 10,000) of configurations for the elements in a manufacturing layout such that the distance between elements is minimized within a placement area. In one approach, the optimization dynamically (e.g., randomly) adjusts a diameter of the placement area from manufacturing specifications (e.g, a minimum distance) between elements being unmet after adding an element. The adjustment of a manufacturing design may continue until satisfying criteria, such as a beam profile or a difference between a main-lobe power and a side-lobe power.

Moreover, the optimization system performs a gradient operation for each position of the elements that factors side-lobe power. Here, the gradient operation can fine-tune configurations by minimizing a penalty associated with the side-lobe power for the elements according to an objective function (e.g., element quantities). In this way, the optimization system improves performance through randomization for initially determining positions and an array design since the gradient operation can be inefficient for non-continuous actions such as adding, removing, grouping, and so on of the elements. Accordingly, the optimization system efficiently determines positions of antenna elements that meet criteria while suppressing side-lobe power by randomization followed by a gradient operation for tuning configurations.

In one embodiment, an optimization system to compute positions for manufacturing elements of an antenna array using randomization and gradient operations that suppress side-lobe power is disclosed. The optimization system includes a processor and a memory storing instructions that, when executed by the processor, cause the processor to compute positions for elements on an antenna array within a placement area using randomization that accounts for varying quantities of the elements according to a distance constraint and a side-lobe power. The instructions also include instructions to adjust the placement area according to a location associated with one of the elements. The instructions also include instructions to optimize, in response to the elements satisfying criteria after predetermined iterations, the positions for a physical layout of the antenna array using a gradient operation according to the side-lobe power.

In one embodiment, a non-transitory computer-readable medium to compute positions for manufacturing elements of an antenna array using randomization and gradient operations that suppress side-lobe power and including instructions that when executed by a processor cause the processor to perform one or more functions is disclosed. The instructions include instructions to compute positions for elements on an antenna array within a placement area using randomization that accounts for varying quantities of the elements according to a distance constraint and a side-lobe power. The instructions also include instructions to adjust the placement area according to a location associated with one of the elements. The instructions also include instructions to optimize, in response to the elements satisfying criteria after predetermined iterations, the positions for a physical layout of the antenna array using a gradient operation according to the side-lobe power.

In one embodiment, a method for computing positions for manufacturing elements of an antenna array using randomization and gradient operations that suppress side-lobe power is disclosed. In one embodiment, the method includes computing positions for elements on an antenna array within a placement area using randomization that accounts for varying quantities of the elements according to a distance constraint and a side-lobe power. The method also includes adjusting the placement area according to a location associated with one of the elements. The method also includes, in response to the elements satisfying criteria after predetermined iterations, optimizing the positions for a physical layout of the antenna array using a gradient operation according to the side-lobe power.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which an antenna array designed by an optimization system may be implemented.

FIG. 2 illustrates one embodiment of the optimization system that is associated with using a Monte Carlo (MC) method and gradient operations for positioning elements associated with the antenna array.

FIG. 3A illustrates one example of a layout and beams of an antenna array generated using the MC method and gradient operations.

FIG. 3B illustrates one example of co-designing a physical layout of a receiver (RX) array according to a transmitter (TX) beam using the optimization system.

FIG. 4 illustrates one embodiment of the optimization system determining the positions and layout of the elements within a constrained circle.

FIG. 5 illustrates one example of an antenna system having elements with positions and a layout determined by the optimization system.

FIG. 6 illustrates one embodiment of a method that is associated with using the MC method and gradient operations for positioning elements of the antenna array associated with manufacturing.

### DETAILED DESCRIPTION

Systems, methods, and other embodiments associated with computing element positions for manufacturing an antenna array using randomization and gradient operations that suppress side-lobe power and improve beam profiles are disclosed herein. In various implementations, systems that design layouts for manufacturing antenna arrays encounter irregular configurations that form distorted or disfigured beams. For instance, beams formed by an antenna array using a physical layout designed by a system have a diminished main-lobe power and an elevated side-lobe power that reduces accuracy for scanning. Furthermore, systems that determine physical layouts for an antenna array can be computationally expensive or select designs that reduce manufacturing yields. Therefore, in one embodiment, an optimization system computes positions for elements (e.g., emitters, conductors, etc.) on an antenna array associated with a design using randomization while accounting for varying element quantities and layout distributions. Here, a Monte Carlo (MC) method may efficiently randomize the positions within a placement area (e.g., circle) according to a distance constraint and a side-lobe power while changing element quantities for identifying optimal physical layouts. In one approach, the distance constraint is set by manufacturing specifications and the side-lobe power is associated with a design profile (e.g., beam shapes, steering applications, etc.) for the antenna array. Furthermore, the optimization system adjusts the placement area diameter dynamically (e.g., randomly) until satisfying criteria (e.g., main-lobe power, phase shifter quantity, etc.) by moving, adding, or removing elements amongst valid positions within a physical layout. This may continue iteratively until convergence of side-lobe power or activating a certain quantity of phase shifters (i.e., beam controllers, steering adaptors, etc.) for the design profile.

Moreover, the optimization system uses a gradient operation to optimize the positions for the physical layout, such as by minimizing a penalty associated with the side-lobe power. Here, the penalty may be the total power generated by side-lobes associated with a main-lobe being within a threshold (e.g., −20 dB). In various implementations, the optimization system randomizes and uses gradient operations for positioning the elements according to a pattern for manufacturing vehicle radar. As a result, the approach increases fabrication yield while reducing phase shifter quantities. Accordingly, the optimization system uses randomizations with gradient operations to efficiently compute physical layouts for antenna arrays that improves suppression of side-lobe power and increases manufacturing yield while satisfying a design profile.

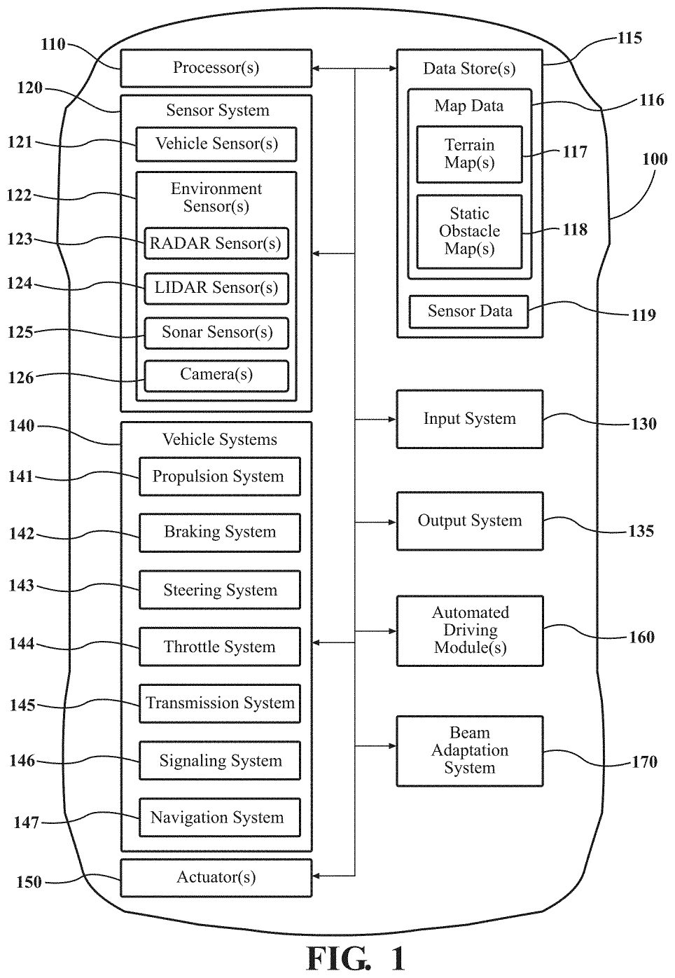

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a beam adaptation system 170 uses road-side units (RSU), consumer electronics (CE), mobile devices, robots, drones, and so on that benefit from the functionality discussed herein.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances.

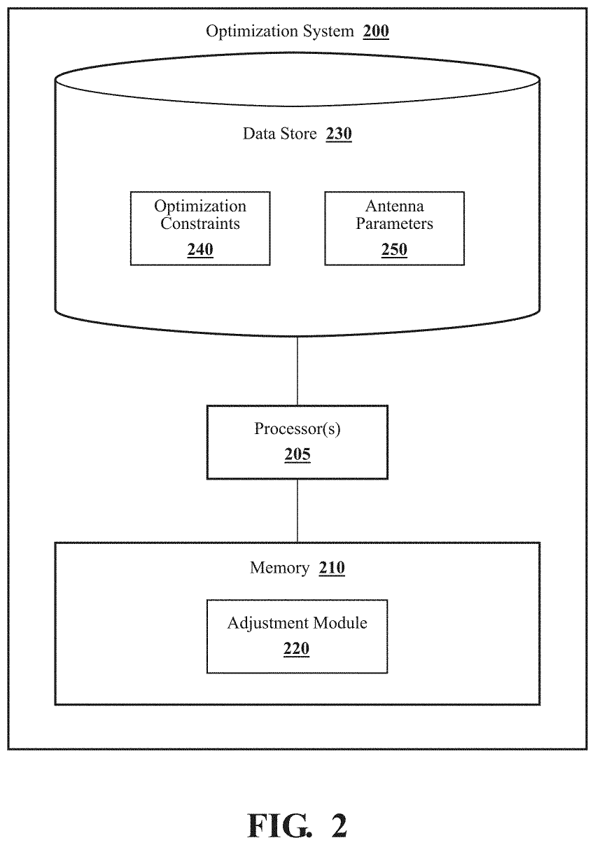

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

With reference to FIG. 2, one embodiment of an optimization system 200 is illustrated. The optimization system 200 includes a memory 210 that stores an adjustment module 220. The memory 210 is a random-access memory (RAM), a read-only memory (ROM), a hard-disk drive, a flash memory, or other suitable memory for storing the adjustment module 220. The adjustment module 220 is, for example, computer-readable instructions that when executed by the processor(s) 205 cause the processor(s) 205 to perform the various functions disclosed herein.

The optimization system 200 as illustrated in FIG. 2 is generally an abstracted form of the optimization system 200 as may be implemented. The adjustment module 220 generally includes instructions that function to control the processor(s) 205 to receive data inputs. The inputs are, in one embodiment, the optimization constraints 240 that the optimization system 200 utilizes to determine positions for a design profile. In one embodiment, the optimization system 200 includes a data store 230, such as a database. The database is, in one embodiment, an electronic data structure stored in the memory 210 or another data store and that is configured with routines that can be executed by the processor(s) 205 for analyzing stored data, providing stored data, organizing stored data, and so on. Thus, in one embodiment, the data store 230 stores data used by the adjustment module 220 in executing various functions.

Moreover, the data store 230 includes the optimization constraints 240. These constraints may include a minimum distance between elements from manufacturing specifications, a distribution size for randomization, a group size for elements, a diameter of a placement area, and so on. Furthermore, the data store 230 includes antenna parameters 250 such as a side-lobe power, a main-lobe power, a main-lobe gain, a design pattern, a beam shape, phase shifter quantity for beamsteering, and so on that the optimization system 200 uses for determining physical layouts.

In various implementations, the adjustment module 220 includes instructions that cause the processor 205 to compute initial positions, groupings, or ungroupings of elements on an antenna array within a placement area using randomization for manufacturing. Here, the randomization may be a MC method that initially accounts for varying quantities of the elements according to a distance constraint and a side-lobe power. The MC method may also coarsely adjust the placement area according to locations of elements added, grouped, or moved for satisfying a design profile of the antenna array before a gradient operation is performed and reducing the side-lobe power. In this way, the MC method factors non-continuous physical layouts and element positions outside the capabilities of gradient optimization through adding, grouping, or removing elements.

As further explained below, the optimization system 200 performs the gradient operation once elements during the randomization satisfy criteria or until an iteration limit (e.g., computation usage) is met for fine-tuning the positions within a physical layout associated with manufacturing. In this way, side-lobe power is suppressed while forming augmented main-lobes by the optimization system 200 adding, removing, grouping, or ungrouping elements according to a design profile. For instance, the adjustment module 220 reduces side-lobe power up to −30 dB while having a main-lobe at 0 dB by reducing element activity or quantities. Furthermore, other improvements for beamforming and steering herein involve reducing errors that contribute to side-lobe power by reducing phase shifter usage.

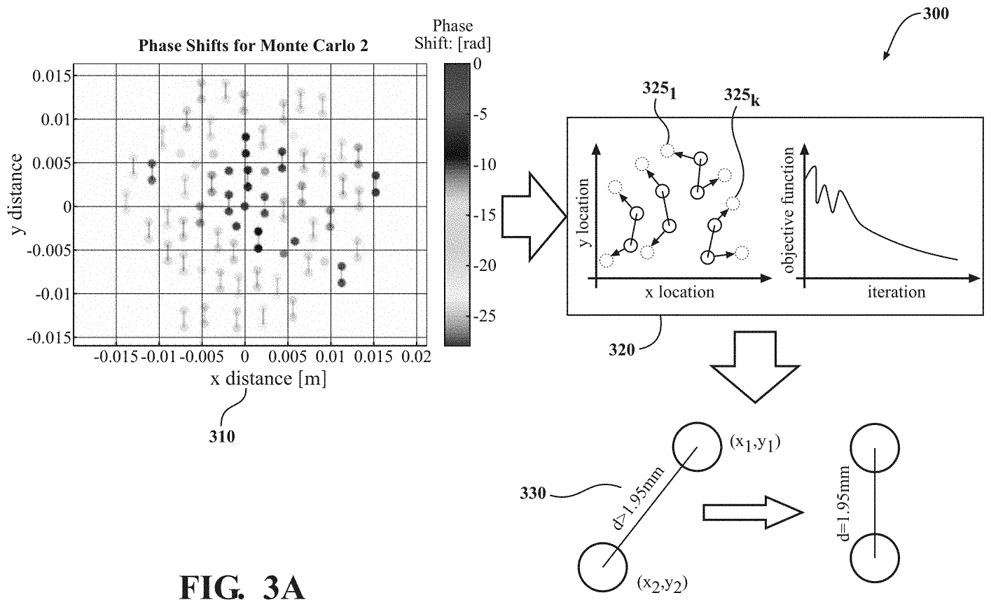

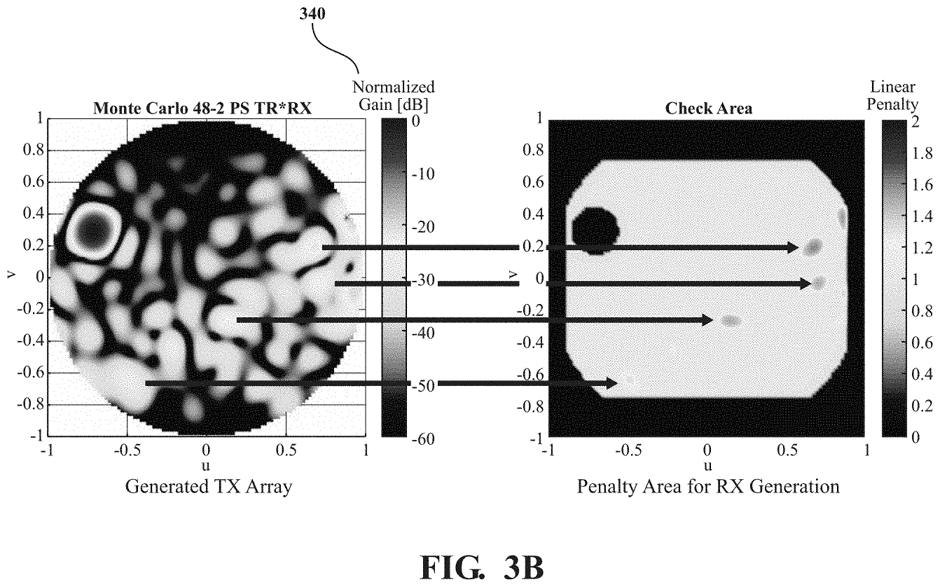

Turning now to FIG. 3A, one embodiment of the optimization system 200 using a MC method and gradient operations for positioning elements associated with an antenna array 300 is illustrated. For example, the antenna array 300 is manufactured and used by the beam adaptation system 170 to perceive a vehicle environment, detect objects, navigate the vehicle 100, and so on. Here, the optimization system 200 evaluates phase shifts and element grouping effects in 310 through the MC method. For example, the optimization system 200 randomly positions elements into valid positions until 64 phase shifters are active. This operation may involve grouping elements of various shapes or sizes. In various implementations, the MC method samples a distribution (e.g., 1000) of antenna arrays with limited computation costs until identifying candidate geometries represented by x, y positions of active elements. A geometry can also be associated with beam characteristics having suppressed side-lobe power while satisfying a design profile. For example, an identified geometry may have a side-lobe in a similar position relative to a main-lobe before randomization with reduced power (e.g., 3 dB-4 dB, 50% reduced penalty, etc.).

The optimization system 200 uses the results from 310 to perform gradient operation 320 that further reduces side-lobe power. Here, the optimization system 200 may move elements at x, y locations iteratively to 325₁-325ₖ according to gradient values associated with an objective function and the optimization constraints 240. An iteration attempts to reduce or minimize the objective function that may represent the total side-lobe power above a threshold (e.g., −20 dB). For example, the positioning is altered according to changes in the gradient or slope of the objective function. In one approach, an objective function evaluates the greatest side lobe in an array factor, a sum of side lobe power within a steering region, or a main beam shape. As such, the optimization system 200 can adjust the positioning using these factors of the objective function.

In various implementations, the optimization system 200 uses the gradient operations described in “Optimization of Planar Phased Arrays for Vehicles” by Schmalenberg et al., herein incorporated by reference as if fully set forth. In particular, a non-linear operation geometrically optimizes element positions through array constraints and accelerates processing using uv-projection planes beyond the unit circle. Uv-projection is a mapping that represents 3D hemispheres on a 2D plane. The 2D plane representation can be created by viewing the 3D hemisphere from a top-down viewpoint. In this way, the 3D hemisphere is free of occlusions.

The optimization system 200 can also suppress powerful side-lobes according to application (e.g., environment scanning, beamsteering, etc.) through penalization within a defined area. Here, the defined area may be called a penalty that is double the size of an application area (e.g., beamsteering area) in uv-coordinates. As such, the optimization system 200 integrates side-lobe power occurring within the penalty domain to formulate and minimize an objective function.

Moreover, the optimization system 200 may place absolute constraints on an antenna array size and elements for gradient operations. For example, an array area is split into quadrants with an equal number of elements assigned to each quadrant. As such, an element may be constrained to an originating quadrant. In this way, the optimization system 200 avoids translations of identical physical layouts or rotation of elements around the origin when using a penalty domain with rotational symmetry.

In addition, the optimization system 200 optimizes the geometry 330 by grouping elements to have similar relations while suppressing side-lobe or grating power. In this way, the optimization system 200 prevents identifying candidate geometries that complicate design, fabrication, or yield through layout regularization. For example, a manufacturing specification lists measures, geometries, and so on to fabricate an antenna array in a system that ensures operability and durability. As such, the optimization system 200 efficiently finds and adjusts patterns for physical layouts according to the manufacturing specification. In one approach, initial positions are computed using the MC method within parameter ranges of the manufacturing specification. The optimization system 200 then adjusts or optimizes the initial positions using the gradient operation for a physical layout that approaches tolerance limits for the manufacturing specification. In this way, manufacturing of the antenna array reduces design time and costs while improving main-lobe performance by suppressing side-lobe power.

Moreover, factoring manufacturing specifications and parameters can also reduce control element quantities for a beam profile, thereby improving cost savings. As such, a physical layout of an antenna array may be regularized along the X-axis and Y-axis following:

x_{1new},x_{2new}=(x₁+x₂)/2. Equation (1)

y_{furthest}=y_{closest}±d_{min_distance}. Equation (2)

y_{closet}=y_{closest}. Equation (3)

Here, X-axis regularization may average old coordinates to update x coordinates through the optimization. Similarly, Y-axis regularization may involve the optimization system 200 modifying the distance between element pairs that are grouped. For example, the distance is a minimum of constrained spacing. However, an element position within a pair proximate to an origin can remain unchanged while modifying the element furthest from the origin. As such, Equation (3) symbolizes removing the spacing between element pairs and setting the element furthest from the origin to the minimum distance d_{min_distance} This parameter is positive or negative when the element pair is above or below the origin on the Y-axis, respectively.

Regarding the graph 340 in FIG. 3B, the optimization system 200 may co-design the physical layout of the receiver (RX) array according to the transmitter (TX) beam, thereby further reducing side-lobe power for a system. Here, the optimization system 200 identifies a TX array using the MC method and extracts substantial side-lobes from the array function of the TX array, thereby further reducing side-lobe power. This action can involve increasing the penalties associated with the objective function at substantial side-lobe locations. In this way, nulls of the RX cancel side-lobes for the TX on a device (e.g., vehicle radar). The reduction in side-lobe power at the TX and RX arrays can also be combined or summed to meet a design threshold (e.g., −30 dB). Furthermore, the number of used or active phase shifters can be reduced while suppressing side-lobes through co-design and coordination of TX and RX array pairs by the optimization system 200, thereby reducing manufacturing costs.

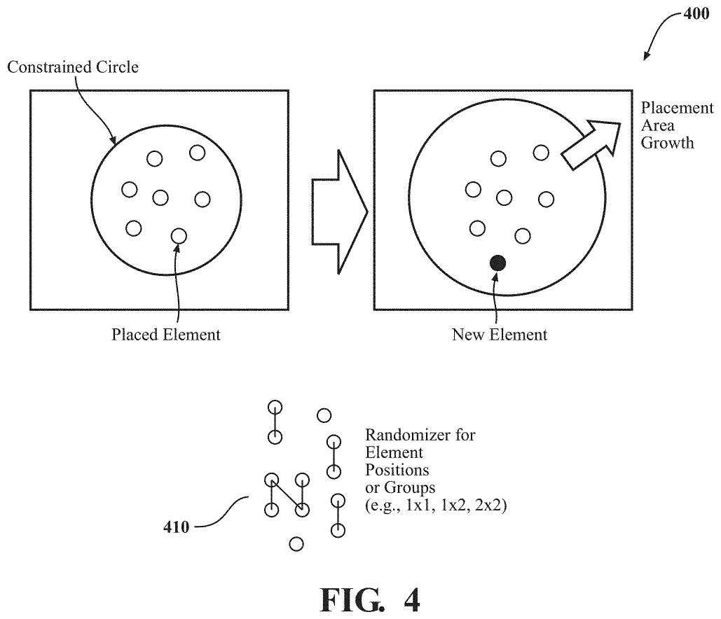

Turning now to FIG. 4, one embodiment of the optimization system 200 determining the positions and layout of the elements within a constrained circle is illustrated with 400. Here, the circle identifies a valid area for placing the elements by a MC method using the randomizer 410 that satisfies a minimum distance, buffer, application, and so on for fabricating an antenna array. The optimization system 200 may remove a placed element once the constrained circle is filled and a parameter from the optimization constraints 240 is violated. A new random area is selected after the removal by expanding the circle diameter and a new element is added. In one approach, the new element is randomly placed. The optimization system 200 continues adding, removing, and grouping elements through the MC method and circle adjustments (e.g., growing, shrinking, etc.) until satisfying space reduction, beam characteristics, phase shifter utility, and so on. Iterations may also continue until a physical layout uses a predetermined amount of phase shifters. In this way, the optimization system 200 finds favorable candidate geometries and avoids bad designs while reducing search times using the MC method.

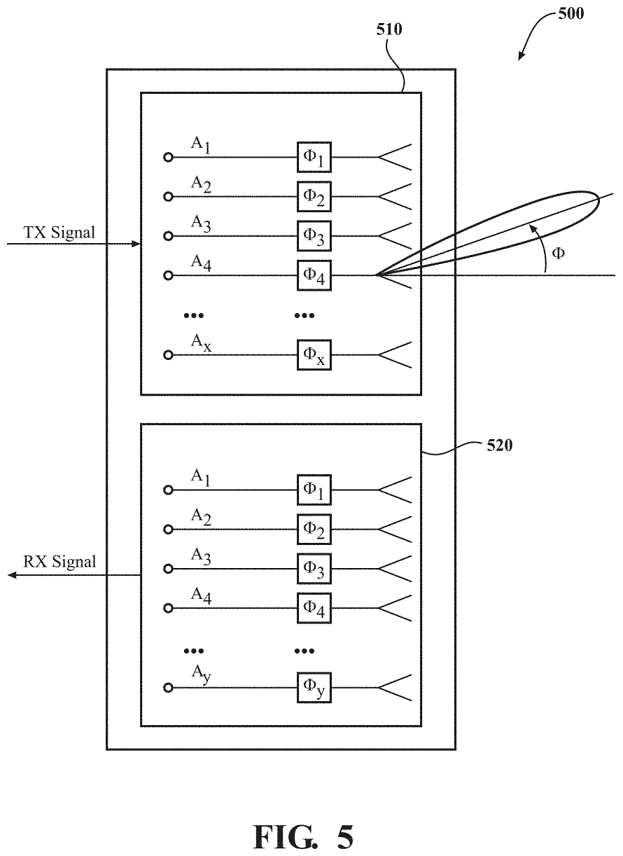

Now turning to FIG. 5, one example of an antenna system 500 having elements with positions and a physical layout determined by the optimization system 200 is illustrated. Here, a transmitter 510 has antenna elements A₁ to Aₓ and phase shifters Φ₁ to Φₓ in the physical layout determined by the optimization system 200 through the MC method with gradient operations. A receiver 520 has elements A₁ to A_{y} and phase shifters Φ₁ to Φ_{y} in the physical layout. In one approach, the receiver 520 is co-designed according to the graph 340. As such, the beam adaptation system 170 may use the antenna system 500 to scan a vehicle environment for obstacles accurately with the suppressed side-lobes and augmented main-lobes. The scan is enhanced by element geometries from the physical layout.

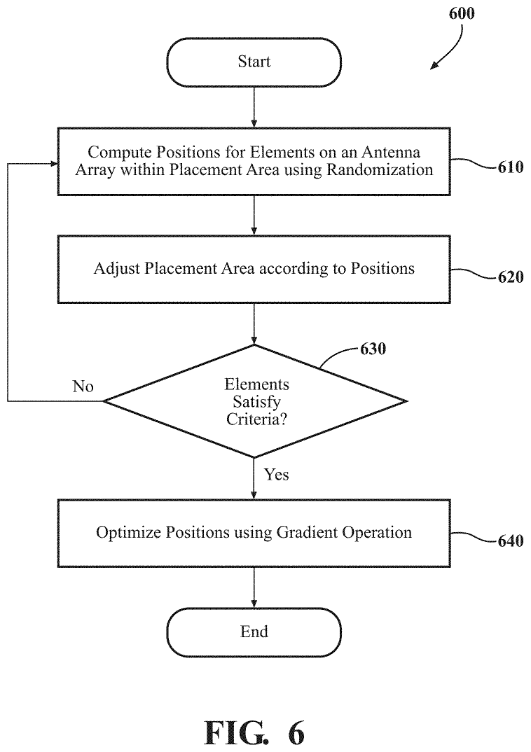

Now turning to FIG. 6, a flowchart of a method 600 that is associated with using the MC method and gradient operations for positioning elements of an antenna array associated with manufacturing is illustrated. Method 600 will be discussed from the perspective of the optimization system 200 of FIG. 2. While the method 600 is discussed in combination with the optimization system 200, it should be appreciated that the method 600 is not limited to being implemented within the optimization system 200 but is instead one example of a system that may implement the method 600.

At 610, the adjustment module 220 computes positions for elements on an antenna array within a placement area using randomization. As previously explained, the initial geometry for the antenna array may be generated or identified using the MC method through a randomized population (e.g., 10,000) of designs. Here, positioning may involve evaluating phase shifts and grouping effects of elements through the MC method while accounting for varying element quantities, manufacturing constraints (e.g., minimum distance), and side-lobe power. For example, the optimization system 200 randomly positions, groups, or moves elements having diverse shapes and sizes into valid positions until 64 phase shifters are active for radar implementations in the vehicle 100. The MC method allows efficiently sampling a population or distribution of antenna arrays until identifying candidate geometries represented by x, y positions meeting a design profile (e.g., beamsteering width) while suppressing side-lobe power. In this way, the MC method factors non-continuous physical layouts and element positions outside the capabilities of gradient optimization through adding, grouping, or removing elements.

In various implementations, the optimization system 200 executes the MC method for reducing hardware components to satisfy costs, size, or design parameters during design and manufacturing. For example, the MC method searches populations to reduce a number of the elements and phase shifters for steering a main beam at a main-lobe power with suppressed side-lobe power while satisfying a distance constraint between elements.

At 620, the optimization system 200 adjusts the placement area according to the positions. In one approach, the optimization system 200 adapts a diameter for the placement area according to the distance constraint being unmet by the location of an element(s). This operation may involve removing an element(s) and reducing the diameter randomly according to a difference between a main-lobe power and the side-lobe power. Conversely, this operation may involve adding an additional element while maintaining or increasing the diameter and satisfying the distance constraint. Furthermore, the optimization system 200 can group the elements using a pattern according to a manufacturing specification for the antenna array. For example, the radar sensors 123 in the vehicle 100 has a physical layout including a rectangular array of TX and RX elements that follow co-design parameters for side-lobe power (e.g., −30 dB) and form factor.

At 630, the optimization system 200 checks that the elements satisfy criteria. For example, the criteria is a difference between a main-lobe power and the side-lobe power. As previously explained, this continues iteratively until reaching a computation limit, beam profile, device size, and so on. Here, the optimization system 200 may output one or more candidate geometries for elements in an antenna array.

At 640, the optimization system 200 optimizes the positions using a gradient operation. Here, the gradient operation may minimize a penalty associated with the side-lobe power for the elements. As previously explained, this operation can involve utilizing a non-linear technique that optimizes with array constraints and accelerates processing using uv-projection planes beyond the unit circle. For example, the optimization system 200 moves elements at x, y locations iteratively according to gradient values associated with an objective function and the optimization constraints 240. Iterations can attempt to reduce or minimize the objective function that represents the total side-lobe power above a threshold (e.g., −20 dB). In one approach, the positioning is altered according to changes in the gradient or slope of the objective function. The optimization system 200 may also alter positions for a particular application (e.g., vehicle environment scanning, beamsteering, etc.) through penalization within a defined area. Here, these factors may be set by manufacturing or design constraints.

In one approach, the method 600 prevents identifying candidate geometries that complicate design, fabrication, or yield through layout regularization. For example, a manufacturing specification lists measures, geometries, and so on to fabricate an antenna array in a system that ensures operability and durability. As such, the optimization system 200 efficiently finds and adjusts patterns for physical layouts according to the manufacturing specification. As such, 610 may involve computing the initial positions using the MC method within parameter ranges of the manufacturing specification. The operations of 620 and 640 may adjust or optimize the initial positions using the gradient operation for a physical layout that approaches tolerance limits from the manufacturing specification. In this way, the optimization system 200 improves the manufacturing of the antenna array by reducing design time, costs, and side-lobe power.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, Programmable Read-Only Memory (PROM), Erasable Programmable Read-Only Memory (EPROM), Electrically Erasable Programmable Read-Only Memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the beam adaptation system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement of the vehicle 100. The processor(s) 110, the beam adaptation system 170, and/or the automated driving module(s) 160 may control some or all of the vehicle systems 140 and, thus, may be partially or fully autonomous as defined by the society of automotive engineers (SAE) levels 0 to 5.

The processor(s) 110, the beam adaptation system 170, and/or the automated driving module(s) 160 can be operatively connected to communicate with the various vehicle systems 140 and/or individual components thereof. For example, returning to FIG. 1, the processor(s) 110, the beam adaptation system 170, and/or the automated driving module(s) 160 can be in communication to send and/or receive information from the various vehicle systems 140 to control the movement of the vehicle 100. The processor(s) 110, the beam adaptation system 170, and/or the automated driving module(s) 160 may control some or all of the vehicle systems 140.

The processor(s) 110, the beam adaptation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the beam adaptation system 170, and/or the automated driving module(s) 160 can control the direction and/or speed of the vehicle 100. The processor(s) 110, the beam adaptation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the beam adaptation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or Flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An optimization system for designing antennas, comprising:
a processor; and
a memory storing instructions that, when executed by the processor, cause the processor to:
compute positions for elements on an antenna array within a placement area using randomization that accounts for varying quantities of the elements according to a distance constraint and a side-lobe power;
adjust the placement area according to a location associated with one of the elements; and
in response to the elements satisfying criteria after predetermined iterations, optimize the positions for a physical layout of the antenna array using a gradient operation according to the side-lobe power.

2. The optimization system of claim 1, wherein the instructions to compute the positions further include instructions to move, using a Monte Carlo method, the positions randomly until a number of phase shifters are active, wherein the Monte Carlo method is associated with a distribution size and the elements are grouped according to one of a shape and a size.

3. The optimization system of claim 2, further including instructions to reduce, using the Monte Carlo method, a number of the elements and the number of phase shifters to steer a main beam at a main-lobe power and the side-lobe power.

4. The optimization system of claim 1, further including instructions to adjust the placement area further includes adapting a diameter for the placement area according to the distance constraint being unmet by the location, wherein the diameter is dynamically selected.

5. The optimization system of claim 4, further including instructions to:
remove the one of the elements; and
reduce the diameter randomly according to a difference between a main-lobe power and the side-lobe power.

6. The optimization system of claim 4, further including instructions to add an additional element while maintaining or increasing the diameter and satisfying the distance constraint.

7. The optimization system of claim 1, wherein the criteria is a difference between a main-lobe power and the side-lobe power and the gradient operation minimizes a penalty associated with the side-lobe power for the elements.

8. The optimization system of claim 1, further comprising instructions to:
group the elements using a pattern according to a manufacturing specification for the antenna array; and
manufacture the antenna array for a radar system according to the physical layout and the pattern.

9. The optimization system of claim 1, wherein the positions are initial positions according to a manufacturing specification associated with a radar system for a vehicle.

10. A non-transitory computer-readable medium comprising:
instructions that when executed by a processor cause the processor to:
compute positions for elements on an antenna array within a placement area using randomization that accounts for varying quantities of the elements according to a distance constraint and a side-lobe power;
adjust the placement area according to a location associated with one of the elements; and
in response to the elements satisfying criteria after predetermined iterations, optimize the positions for a physical layout of the antenna array using a gradient operation according to the side-lobe power.

11. The non-transitory computer-readable medium of claim 10, wherein the instructions to compute the positions further include instructions to move, using a Monte Carlo method, the positions randomly until a number of phase shifters are active, wherein the Monte Carlo method is associated with a distribution size and the elements are grouped according to one of a shape and a size.

12. A method comprising:
computing positions for elements on an antenna array within a placement area using randomization that accounts for varying quantities of the elements according to a distance constraint and a side-lobe power;
adjusting the placement area according to a location associated with one of the elements; and
in response to the elements satisfying criteria after predetermined iterations, optimizing the positions for a physical layout of the antenna array using a gradient operation according to the side-lobe power.

13. The method of claim 12, wherein computing the positions further includes moving, using a Monte Carlo method, the positions randomly until a number of phase shifters are active, wherein the Monte Carlo method is associated with a distribution size and the elements are grouped according to one of a shape and a size.

14. The method of claim 13, further comprising:
reducing, using the Monte Carlo method, a number of the elements and the number of phase shifters to steer a main beam at a main-lobe power and the side-lobe power.

15. The method of claim 12, wherein adjusting the placement area further includes adapting a diameter for the placement area according to the distance constraint being unmet by the location, wherein the diameter is dynamically selected.

16. The method of claim 15, further comprising:
removing the one of the elements; and
reducing the diameter randomly according to a difference between a main-lobe power and the side-lobe power.

17. The method of claim 15, further comprising:
adding an additional element while maintaining or increasing the diameter and satisfying the distance constraint.

18. The method of claim 12, wherein the criteria is a difference between a main-lobe power and the side-lobe power and the gradient operation minimizes a penalty associated with the side-lobe power for the elements.

19. The method of claim 12, further comprising:
grouping the elements using a pattern according to a manufacturing specification for the antenna array; and
manufacturing the antenna array for a radar system according to the physical layout and the pattern.

20. The method of claim 12, wherein the positions are initial positions according to a manufacturing specification associated with a radar system for a vehicle.
